(19) United States
(12) Patent Application Publication
(10) Pub. No.: US 2016/0114795 A1
(43) Pub. Date: Apr. 28, 2016

(54) PARKING ASSIST SYSTEM AND PARKING ASSIST METHOD

(71) Applicants: AISIN SEIKI KABUSHIKI KAISHA, Kariya-shi (JP); TOYOTA JIDOSHA KABUSHIKI KAISHA, Toyota-shi (JP)

(72) Inventors: Yusuke KIYOKAWA, Toyota-shi (JP); Motonari OHBAYASHI, Nagakute-shi (JP)

(73) Assignees: TOYOTA JIDOSHA KABUSHIKI KAISHA, Toyota-shi (JP); AISIN SEIKI KABUSHIKI KAISHA, Kariya-shi (JP)

(21) Appl. No.: 14/922,929

(22) Filed: Oct. 26, 2015

(30) Foreign Application Priority Data
Oct. 28, 2014 (JP) 2014-219711

(51) Int. Cl. B60W 30/06; G01S 13/93; G01S 13/86; G01S 15/93

(52) U.S. Cl. CPC B60W 30/06; G01S 15/931; G01S 13/931; G01S 13/862; G01S 13/867; G01S 2013/9314; G01S 2015/932

(57) ABSTRACT

A parking assist system includes an electronic control unit. The electronic control unit detects a boundary of a parking space, detects a first obstacle within a detection area set at a back-side position within the parking space on the basis of the detected boundary, determines a target position of a moving path of a vehicle on the basis of the detected boundary, and determines the target position such that the vehicle located at the target position overlaps with the first obstacle.

### INCORPORATION BY REFERENCE

The disclosure of Japanese Patent Application No. 2014-219711 filed on Oct. 28, 2014 including the specification, drawings and abstract is incorporated herein by reference in its entirety.

### BACKGROUND OF THE INVENTION

1. Field of the Invention

The invention relates to a parking assist system and a parking assist method.

2. Description of Related Art

Generally, there is known a parking assist system that determines a parking target position on the basis of detected results of ultrasonic sensors (for example, Japanese Patent Application Publication No. 2007-30700 (JP 2007-30700 A)).

In the above existing technique, for example, in a parking space in which a sprag is provided, the sprag is detected as an obstacle, and there is a case where a narrow range on a front side with respect to the sprag and avoiding the sprag within the parking space is identified as an available parking space. In this case, there is a case where no target position is set within the parking space for a vehicle having a size that does not fit into the range.

### SUMMARY OF THE INVENTION

The invention, for example, provides a parking assist system and parking assist method that is able to further increase the number of cases where a parking target position is allowed to be set.

A first aspect of the invention provides a parking assist system. The parking assist system includes an electronic control unit. The electronic control unit is configured to detect a boundary of a parking space, detect a first obstacle within a detection area set at a back-side position within the parking space on the basis of the detected boundary, determine a target position of a moving path of a vehicle on the basis of the detected boundary, and determine the target position such that the vehicle located at the target position overlaps with the first obstacle. That is, the parking assist system according to the aspect is able to set the target position to a position at which the vehicle overlaps with a first obstacle located within a predetermined range based on the detected boundary of the parking space. Thus, for example, in comparison with the case where the target position is set only in an area avoiding the first obstacle, the number of cases where a target position is allowed to be set tends to increase.

A second aspect of the invention provides a parking assist method. The parking assist method includes: detecting a boundary of a parking space; detecting a first obstacle within a detection area set at a back-side position within the parking space on the basis of the detected boundary; determining a target position of a moving path of a vehicle on the basis of the detected boundary; and determining the target position such that the vehicle located at the target position overlaps with the first obstacle. That is, the parking assist method according to the second aspect is able to set the target position to a position at which the vehicle overlaps with a first obstacle located within a predetermined range based on the detected boundary of the parking space. Thus, for example, in comparison with the case where the target position is set only in an area avoiding the first obstacle, the number of cases where a target position is allowed to be set tends to increase.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an exemplary perspective view of a vehicle according to an embodiment in a state where part of a cabin is seen through;

FIG. 2 is an exemplary plan view (bird's-eye view) of the vehicle according to the embodiment;

FIG. 3 is an exemplary block diagram of the configuration of a parking assist system according to the embodiment;

FIG. 4 is an exemplary block diagram of the configuration of part of an ECU of the parking assist system according to the embodiment;

FIG. 5 is a flowchart that shows an example of the procedure of a process that is executed by the parking assist system according to the embodiment;

FIG. 6 is an exemplary schematic plan view of an initial position, paths and target position of the vehicle in the case where the target position is set in correspondence with a parking space by the parking assist system according to the embodiment;

FIG. 7 is an exemplary schematic plan view that shows boundaries of a parking space detected by the parking assist system according to the embodiment, a predetermined range corresponding to the boundaries, and first obstacles detected within the predetermined range;

FIG. 8 is an exemplary schematic plan view that shows the boundaries of the parking space detected by the parking assist system according to the embodiment, the detected first obstacles, and a set target position;

FIG. 9 is an exemplary schematic plan view that shows the shape, different from that of FIG. 7, of a first obstacle within the predetermined range set by the parking assist system according to the embodiment;

FIG. 10 is an exemplary schematic plan view that shows the shape, different from that of FIG. 7 or that of FIG. 9, of a first obstacle within the predetermined range set by the parking assist system according to the embodiment;

FIG. 11 is an exemplary schematic plan view that shows boundaries of a parking space detected by the parking assist system according to the embodiment and second obstacles detected in correspondence with the boundaries;

FIG. 12 is an exemplary schematic plan view that shows the boundaries of the parking space detected by the parking assist system according to the embodiment, the detected second obstacles, and a set target position;

FIG. 13 is an exemplary schematic plan view that shows boundaries of a parking space different from that of FIG. 11 and detected by the parking assist system according to the embodiment, second obstacles detected in correspondence with the boundaries, and a target position;

FIG. 14 is an exemplary schematic plan view that shows boundaries of a parking space different from that of FIG. 11 or that of FIG. 13 and detected by the parking assist system according to the embodiment, second obstacles detected in correspondence with the boundaries, and a target position; and

FIG. 15 is an exemplary schematic plan view that shows boundaries of a parking space detected by the parking assist system according to the embodiment, first or second obstacles detected on the basis of the boundaries, third obstacles detected in correspondence with the boundaries, and a set target position.

### DETAILED DESCRIPTION OF EMBODIMENTS

Hereinafter, an exemplary embodiment of the invention will be described. The configuration of the embodiment described below, and the operation, results and advantageous effects obtained from the configuration are illustrative. The invention may be implemented by a configuration other than the configuration that will be described in the following embodiment, and may obtain at least one of various advantageous effects based on a basic configuration or secondary advantageous effects.

A vehicle 1 according to the present embodiment may be, for example, an automobile that uses an internal combustion engine (not shown) as a drive source, that is, an internal combustion engine automobile, may be an automobile that uses an electric motor (not shown) as a drive source, that is, an electric automobile, a fuel-cell automobile, or the like, may be a hybrid automobile that uses both the internal combustion engine and the electric motor as drive sources, or may be an automobile including another drive source. Various transmissions may be mounted on the vehicle 1. Various devices, such as system and components, required to drive an internal combustion engine or an electric motor may be mounted on the vehicle 1. The system, number, layout, and the like, of a device related to driving of wheels 3 in the vehicle 1 may be variously set.

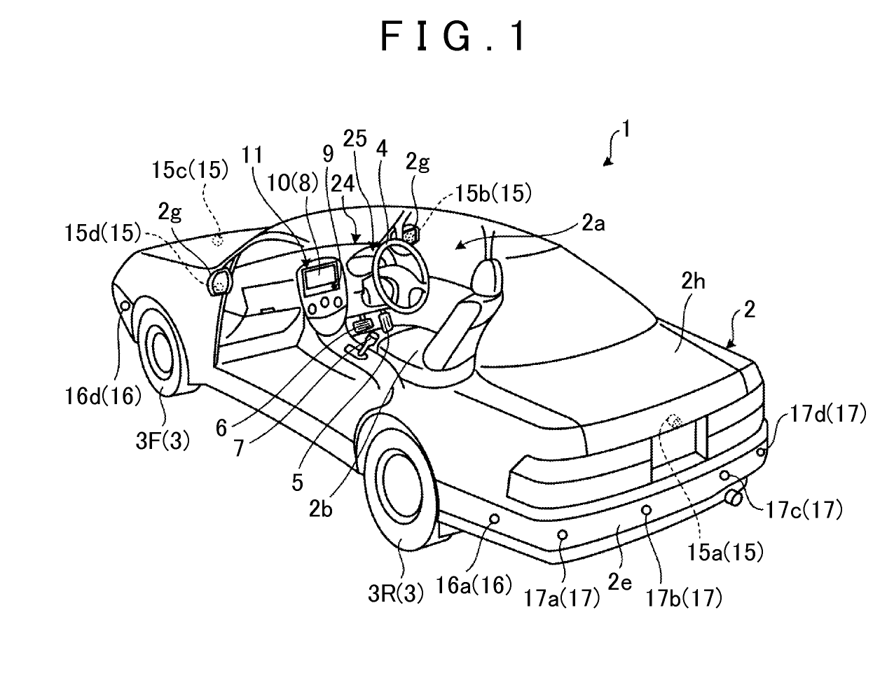

As illustrated in FIG. 1, a vehicle body 2 constitutes a cabin 2a in which an occupant (not shown) is seated. A steering unit 4, an accelerator operation unit 5, a brake operation unit 6, a shift operation unit 7, and the like, are provided near a seat 2b of a driver as an occupant inside the cabin 2a. The steering unit 4 is, for example, a steering wheel projecting from a dashboard 24. The accelerator operation unit 5 is, for example, an accelerator pedal located near driver's foot. The brake operation unit 6 is, for example, a brake pedal located near driver's foot. The shift operation unit 7 is, for example, a shift lever projecting from a center console. The steering unit 4, the accelerator operation unit 5, the brake operation unit 6, the shift operation unit 7, and the like, are not limited to these components.

A display device 8 and an audio output device 9 are provided inside the cabin 2a. The display device 8 serves as a display output unit. The audio output device 9 serves as an audio output unit. The display device 8 is, for example, a liquid crystal display (LCD), an organic electroluminescent display (OELD), or the like. The audio output device 9 is, for example, a speaker. The display device 8 is, for example, covered with a translucent operation input unit 10, such as a touch panel. An occupant is allowed to visually recognize an image that is displayed on the display screen of the display device 8 via the operation input unit 10. An occupant is allowed to perform an input operation by operating the operation input unit 10 through touching, pressing or moving the operation input unit 10 with a finger, or the like, at a position corresponding to an image that is displayed on the display screen of the display device 8. These display device 8, audio output device 9, operation input unit 10, and the like, are, for example, provided in a monitor device 11 located at the center in the vehicle width direction, that is, transverse direction, of the dashboard 24. The monitor device 11 may have an operation input unit (not shown), such as a switch, a dial, a joystick and a push button. An audio output device (not shown) may be provided at another position inside the cabin 2a, different from the monitor device 11. Audio may be output from the audio output device 9 of the monitor device 11 and another audio output device. The monitor device 11 is, for example, shared with a navigation system or an audio system.

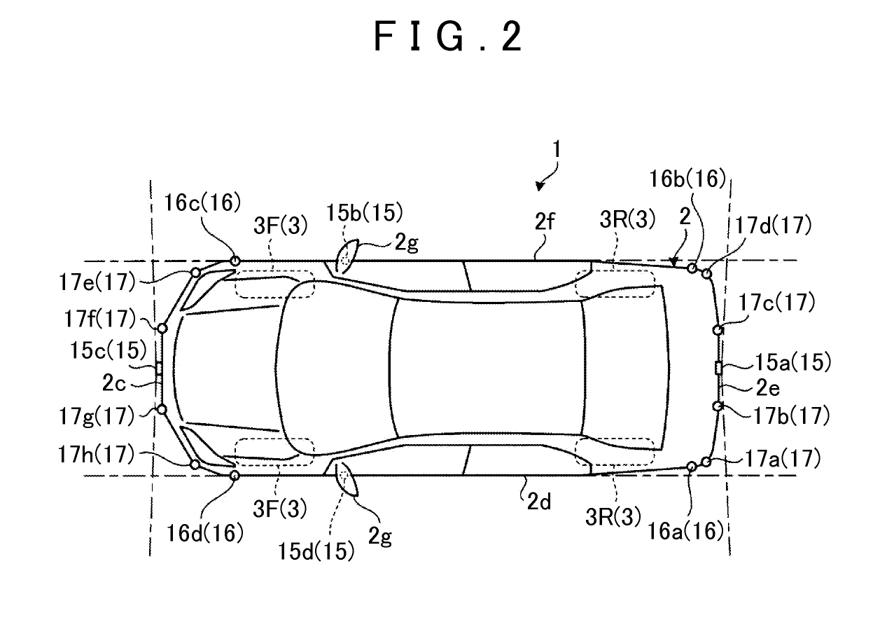

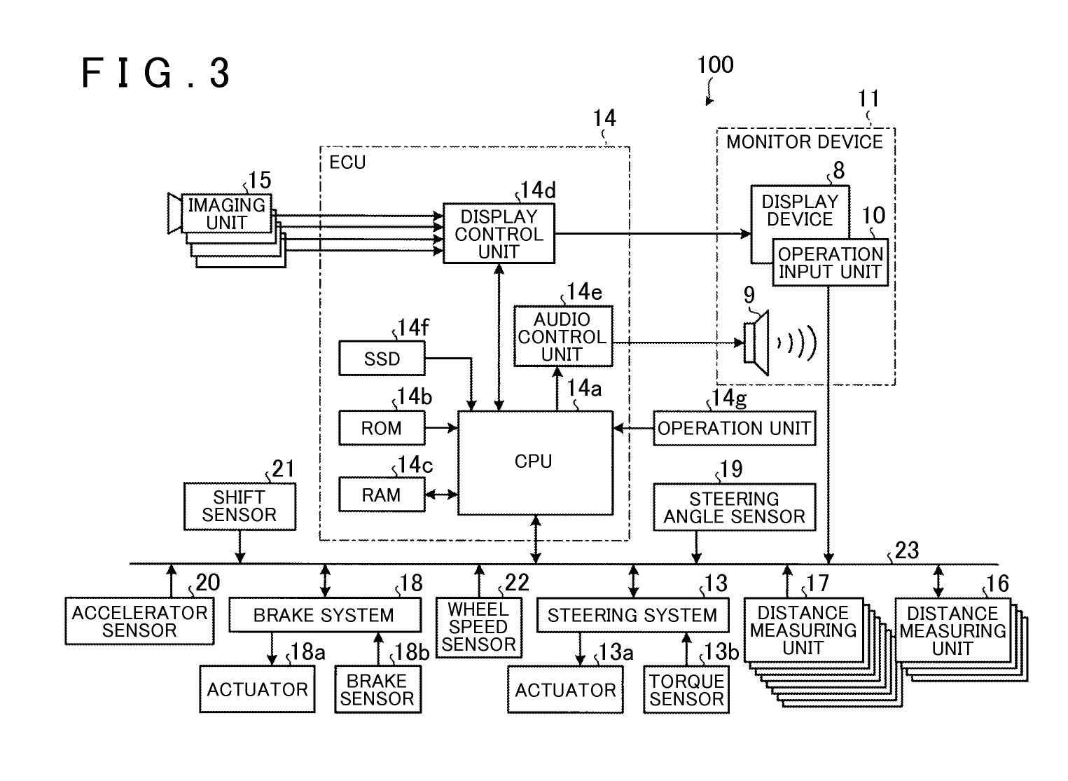

As illustrated in FIG. 1 and FIG. 2, the vehicle 1 is, for example a four-wheel vehicle, and includes two right and left front wheels 3F and two right and left rear wheels 3R. Each of these four wheels 3 may be configured to be steerable. As illustrated in FIG. 3, the vehicle 1 includes a steering system that steers at least two of the wheels 3. The steering system 13 includes an actuator 13a and a torque sensor 13b. The steering system 13 is electrically controlled by an electronic control unit (ECU) 14, or the like, to actuate the actuator 13a. The steering system 13 is, for example, an electric power steering system, a steer-by-wire (SBW) system, or the like. The steering system 13 adds torque, that is, assist torque, to the steering unit 4 with the use of the actuator 13a to compensate for steering force or steers the wheels 3 with the use of the actuator 13a. In this case, the actuator 13a may steer one of the wheels 3 or may steer a plurality of the wheels 3. The torque sensor 13b, for example, detects a torque that is applied to the steering unit 4 by a driver.

As illustrated in FIG. 2, for example, four imaging units 15a to 15d are provided on the vehicle body 2 as a plurality of imaging units 15. Each of the imaging units 15 is, for example, a digital camera that incorporates an imaging device, such as a charge coupled device (CCD) and a CMOS image sensor (CIS). Each of the imaging units 15 is able to output moving image data at a predetermined frame rate. Each of the imaging units 15 has a wide angle lens or a fisheye lens, and is able to capture an image in, for example, the range of 140° to the range of 190° in the horizontal direction. The optical axis of each of the imaging units 15 is set so as to be oriented obliquely downward. Thus, each of the imaging units 15 sequentially captures a road surface on which the vehicle 1 is allowed to move and an outside environment around the vehicle body 2, including an area in which the vehicle 1 is allowed to be parked, and outputs the captured image as captured image data.

The imaging unit 15a is, for example, located at a rear end 2e of the vehicle body 2, and is provided at a lower wall portion of a door 2h of a rear boot. The imaging unit 15b is, for example, located at a right-side end 2f of the vehicle body 2, and is provided at a right-side door mirror 2g. The imaging unit 15c is, for example, located at the front of the vehicle body 2, that is, a front end 2c in the vehicle longitudinal direction, and is provided at a front bumper, or the like. The imaging unit 15d is, for example, located at the left side of the vehicle body 2, that is, a left-side end 2d in the vehicle width direction, and is provided at a door mirror 2g that serves as a left-side projecting portion. The ECU 14 is able to generate an image having a wider viewing angle or generate an imaginary bird's-eye image of the vehicle 1 from above by executing operation processing and image processing on the basis of the image data obtained by the imaging units 15. A bird's-eye image may be referred to as plan image.

The ECU 14 identifies partition lines, or the like, on a road surface around the vehicle 1 from the images of the imaging units 15, and detects (extracts) parking spaces indicated by the partition lines, or the like.

As illustrated in FIG. 1 and FIG. 2, for example, four distance measuring units 16a to 16d and eight distance measuring units 17a to 17h are provided on the vehicle body 2 as a plurality of distance measuring units 16, 17. Each of the distance measuring units 16, 17 is, for example, a sonar that emits ultrasonic wave and captures the reflected wave. The sonar may also be referred to as a sonar sensor or an ultrasonic detector. The ECU 14 is able to detect whether there is an object, such as an obstacle, located around the vehicle 1 or measure a distance to the object on the basis of the detected results of the distance measuring units 16, 17. That is, each of the distance measuring units 16, 17 is an example of a detection unit that detects an object. Each of the distance measuring units 17 may be, for example, used to detect an object at a relatively close distance. Each of the distance measuring units 16 may be, for example, used to detect an object at a relatively long distance, which is distant from an object that each of the distance measuring units 17 detects. The distance measuring units 17 may be, for example, used to detect an object ahead of or behind the vehicle 1. The distance measuring units 16 may be, for example, used to detect an object to the side of the vehicle 1. Each of the distance measuring units 16, 17 may be a radar device, or the like.

As illustrated in FIG. 3, in a parking assist system 100, in addition to the ECU 14, the monitor device 11, the steering system 13, the distance measuring units 16, 17, and the like, a brake system 18, a steering angle sensor 19, an accelerator sensor 20, a shift sensor 21, a wheel speed sensor 22, and the like, are electrically connected to one another via an in-vehicle network 23 that serves as an electric communication line. The in-vehicle network 23 is, for example, provided as a controller area network (CAN). The ECU 14 is able to control the steering system 13, the brake system 18, and the like, by transmitting control signals through the in-vehicle network 23. The ECU 14 is able to receive detected results of the torque sensor 13b, a brake sensor 18b, the steering angle sensor 19, the distance measuring units 16, the distance measuring units 17, the accelerator sensor 20, the shift sensor 21, the wheel speed sensor 22, and the like, and operation signals of the operation input unit 10, and the like, via the in-vehicle network 23.

The ECU 14, for example, includes a central processing unit (CPU) 14a, a read only memory (ROM) 14b, a random access memory (RAM) 14c, a display control unit 14d, an audio control unit 14e, a solid state drive or flash memory (SSD) 14f, and the like. The CPU 14a is, for example, able to execute various operation processing and control, such as image processing related to images that are displayed on the display device 8, determination of a target position of the vehicle 1, computation of a moving path of the vehicle 1, determination as to whether there is an interference with an object, automatic control over the vehicle 1, and cancellation of automatic control. The CPU 14a is able to read a program installed and stored in a nonvolatile storage device, such as the ROM 14b, and execute operation processing in accordance with the program. The RAM 14c temporarily stores various pieces of data that are used for computation in the CPU 14a. The display control unit 14d mainly executes image processing by the use of image data obtained by the imaging units 15, synthesis of image data that are displayed on the display device 8, and the like, within the operation processing in the ECU 14. The audio control unit 14e mainly processes audio data that are output from the audio output device 9 within the operation processing in the ECU 14. The SSD 14f is a rewritable nonvolatile storage unit, and is able to store data even when the power of the ECU 14 is turned off. The CPU 14a, the ROM 14b, the RAM 14c, and the like, may be integrated within the same package. The ECU 14 may be formed of another logical operation processor, such as a digital signal processor (DSP), a logical circuit, or the like, instead of the CPU 14a. A hard disk drive (HDD) may be provided instead of the SSD 14f. The SSD 14f or the HDD may be provided separately from the ECU 14. The ECU 14 is an example of an electronic control unit of a parking assist system.

The brake system 18 is, for example, an anti-lock brake system (ABS) that prevents the brake from locking up the wheels, a side slip prevention device (electronic stability control (ESC)) that prevents a side slip of the vehicle 1 during cornering, an electric brake system that enhances brake force (performs brake assist), a brake-by-wire (BBW), or the like. The brake system 18 imparts braking force to the wheels 3 and, by extension, the vehicle 1, via the actuator 18a. The brake system 18 is able to execute various controls by detecting locking up of the wheels by the brake, a spin of the wheels 3, a sign of a side slip, and the like, from, for example, a rotation difference between the right and left wheels 3. The brake sensor 18b is, for example, a sensor that detects the position of a movable unit of the brake operation unit 6. The brake sensor 18b is able to detect the position of the brake pedal that serves as the movable unit. The brake sensor 18b includes a displacement sensor.

The steering angle sensor 19 is, for example, a sensor that detects a steering amount of the steering unit 4, such as the steering wheel. The steering angle sensor 19 is, for example, provided by using a Hall element, or the like. The ECU 14 acquires a driver's steering amount of the steering unit 4, a steering amount of each wheel 3 during automatic steering, or the like, from the steering angle sensor 19, and executes various controls. The steering angle sensor 19 detects a rotation angle of a rotating portion included in the steering unit 4. The steering angle sensor 19 is an example of an angle sensor.

The accelerator sensor 20 is, for example, a sensor that detects the position of a movable unit of the accelerator operation unit 5. The accelerator sensor 20 is able to detect the position of the accelerator pedal that serves as the movable unit. The accelerator sensor 20 includes a displacement sensor.

The shift sensor 21 is, for example, a sensor that detects the position of a movable unit of the shift operation unit 7. The shift sensor 21 is able to detect the position of a lever, an arm, a button, or the like, that serves as the movable unit. The shift sensor 21 may include a displacement sensor or may be provided as a switch.

The wheel speed sensor 22 is a sensor that detects a rotation amount or rotation speed of each wheel 3 per unit time. The wheel speed sensor 22 outputs a wheel speed pulse number, indicating the detected rotation speed, as a sensor value. The wheel speed sensor 22 may be, for example, provided by using a Hall element, or the like. The ECU 14 computes a moving amount, and the like, of the vehicle 1 on the basis of the sensor value acquired from the wheel speed sensor 22, and executes various controls. There is a case where the wheel speed sensor 22 is provided in the brake system 18. In this case, the ECU 14 acquires the detected result of the wheel speed sensor 22 via the brake system 18.

The configurations, arrangement, electrical connection modes, and the like, of the above-described various sensors and actuators are illustrative, and may be variously set (changed).

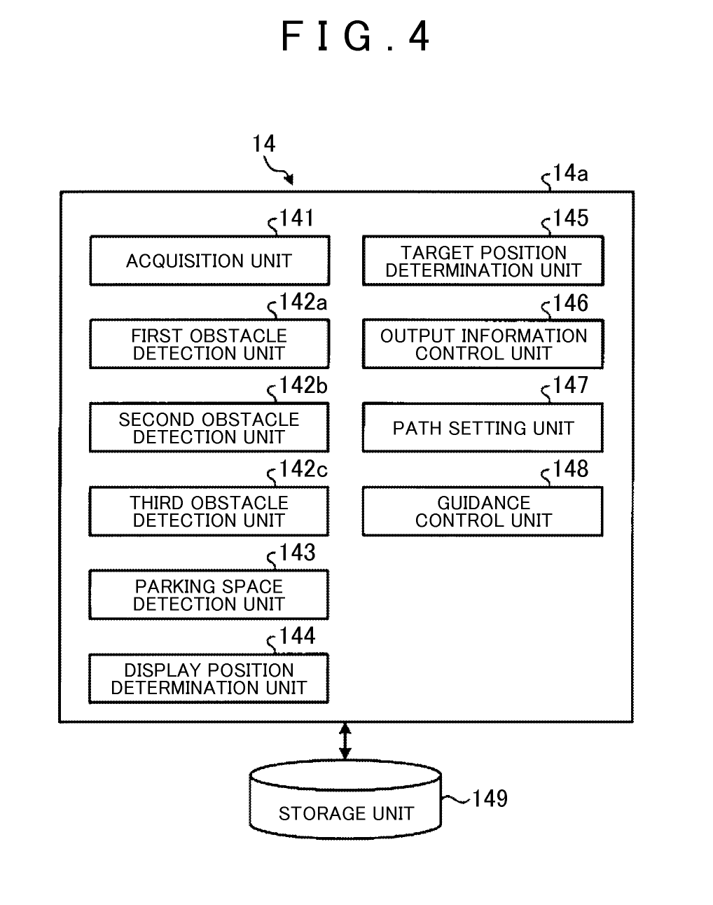

As shown in FIG. 4, the ECU 14 includes an acquisition unit 141, a first obstacle detection unit 142a, a second obstacle detection unit 142b, a third obstacle detection unit 142c, a parking space detection unit 143, a display position determination unit 144, a target position determination unit 145, an output information control unit 146, a path setting unit 147, a guidance control unit 148, a storage unit 149, and the like. The CPU 14a functions as the acquisition unit 141, the first obstacle detection unit 142a, the second obstacle detection unit 142b, the third obstacle detection unit 142c, the parking space detection unit 143, the display position determination unit 144, the target position determination unit 145, the output information control unit 146, the path setting unit 147, the guidance control unit 148, or the like, by executing a process in accordance with a corresponding program. Data that are used in operation processes of the units, data of results in operation processes, and the like, are stored in the storage unit 149. At least part of the functions of the above-described units may be implemented by hardware.

The acquisition unit 141 acquires various pieces of data, signals, and the like. The acquisition unit 141, for example, acquires data, signals, and the like, such as detected results of the sensors, input operations, input commands, and image data. The acquisition unit 141 is able to acquire a signal resulting from an input operation of the operation unit 14g. The operation unit 14g is, for example, a push button, a switch, or the like.

Each of the first obstacle detection unit 142a, the second obstacle detection unit 142b and the third obstacle detection unit 142c detects an obstacle that interferes with traveling of the vehicle 1. The obstacle is, for example, another vehicle, a wall, a pole, a fence, a protrusion, a step, a sprag, an object, or the like. Each of the first obstacle detection unit 142a, the second obstacle detection unit 142b and the third obstacle detection unit 142c is able to detect whether there is an obstacle, the height of an obstacle, the size of an obstacle, and the like, by the use of various techniques. Each of the first obstacle detection unit 142a, the second obstacle detection unit 142b and the third obstacle detection unit 142c is, for example, able to detect an obstacle on the basis of detected results of the distance measuring units 16, 17. Alternatively, each of the first obstacle detection unit 142a, the second obstacle detection unit 142b and the third obstacle detection unit 142c may detect the height of an obstacle on the basis of the detected results of the distance measuring units 16, 17 and the heights of beams of the distance measuring units 16, 17. Each of the first obstacle detection unit 142a, the second obstacle detection unit 142b and the third obstacle detection unit 142c may detect whether there is an obstacle or the height of an obstacle on the basis of a detected result of the wheel speed sensor 22 or an acceleration sensor (not shown) and detected results of the distance measuring units 16, 17. Each of the first obstacle detection unit 142a, the second obstacle detection unit 142b and the third obstacle detection unit 142c may, for example, detect the height of an obstacle through image processing based on images captured by the imaging units 15.

Each of the first obstacle detection unit 142a, the second obstacle detection unit 142b and the third obstacle detection unit 142c detects an obstacle that satisfies a corresponding one of conditions. This will be described later.

The parking space detection unit 143 detects a parking space that is provided as a mark or an object. The parking space is a space that is a target or reference set such that the vehicle 1 is parked in that place. A parking boundary (boundary) is a boundary or outer periphery of the parking space, and is, for example, a partition line, a frame line, a straight line, a band, a step, an edge of any one of them, or the like. That is, the parking boundary is a mark, an object, or the like. The parking space detection unit 143 is, for example, able to detect a parking space and a parking boundary through image processing based on images captured by the imaging units 15. The parking space detection unit 143 is an example of a boundary detection unit.

The display position determination unit 144, for example, determines a display position of a display element, which is a guide or target to which the vehicle 1 is guided, on the basis of at least one of a detected result of any of the obstacle detection units 142a, 142b, 142c and a detected result of the parking space detection unit 143. The display position may correspond to a terminal of a moving path, or may correspond to a halfway position of the moving path. The display element is, for example, set as a point, line, frame, area, or the like, which is displayed on the display device 8.

The target position determination unit 145, for example, determines a target position, which is a guide or target position to which the vehicle 1 is guided, on the basis of at least one of a detected result of any of the obstacle detection units 142a, 142b, 142c and a detected result of the parking space detection unit 143. The target position may correspond to a terminal of the moving path, or may correspond to a halfway position of the moving path. The target position is, for example, set as a point, line, frame, area, or the like. The target position may be the same as the display position.

The output information control unit 146, for example, controls the display control unit 14d or the audio control unit 14e, by extension, the display device 8 or the audio output device 9, such that the display device 8 or the audio output device 9 outputs intended information in an intended mode at each of steps, such as a start of parking assist, an end of parking assist, determination of a target position, calculation of a path and guidance control.

The path setting unit 147, for example, sets a moving path from the current position of the vehicle 1 to the target position on the basis of the current position of the vehicle 1, that is, the host vehicle, the determined target position, the detected obstacle, and the like, by the use of a known technique, or the like.

The guidance control unit 148 controls the portions such that the vehicle 1 moves along the calculated moving path. In the vehicle 1 that moves by the use of creeping, or the like, without operating the accelerator pedal, the guidance control unit 148 is, for example, able to move the vehicle 1 along the moving path by controlling the steering system 13 in response to the position of the vehicle 1. The guidance control unit 148 may control not only the steering system 13 but also a drive mechanism, such as an engine and a motor, the brake system 18 that serves as a braking mechanism, or the like. The guidance control unit 148 may, for example, inform the driver of movement of the vehicle 1 along the moving path through display output or audio output commensurate with the position of the vehicle 1 by controlling the output information control unit 146, the display control unit 14d or the audio control unit 14e, by extension, the display device 8 or the audio output device 9.

The storage unit 149 stores data that are used in computation in the ECU 14 or data calculated in computation in the ECU 14.

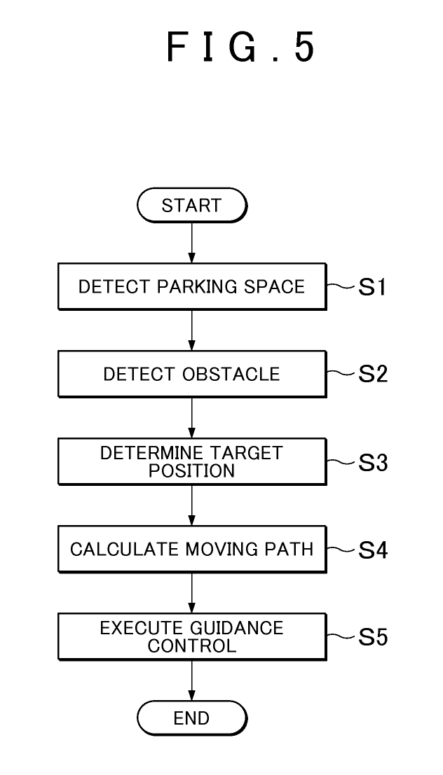

In the parking assist system 100, a process is executed in accordance with the procedure illustrated in FIG. 5. Initially, the parking space detection unit 143 detects a parking space and a parking boundary (S1). Each of the first obstacle detection unit 142a, the second obstacle detection unit 142b and the third obstacle detection unit 142c detects an obstacle that satisfies a corresponding one of the conditions (S2). Subsequently, the target position determination unit 145 determines a target position of a moving path of the vehicle 1 on the basis of the detected results of S1 and S2 (S3). Subsequently, the path setting unit 147 calculates a moving path from the current position of the vehicle 1 to the determined target position (S4). Subsequently, the guidance control unit 148 controls the portions such that the vehicle 1 moves along the calculated moving path (S5). The target position, the moving path, or the like, may be corrected or updated as needed in the middle of movement of the vehicle 1 along the moving path.

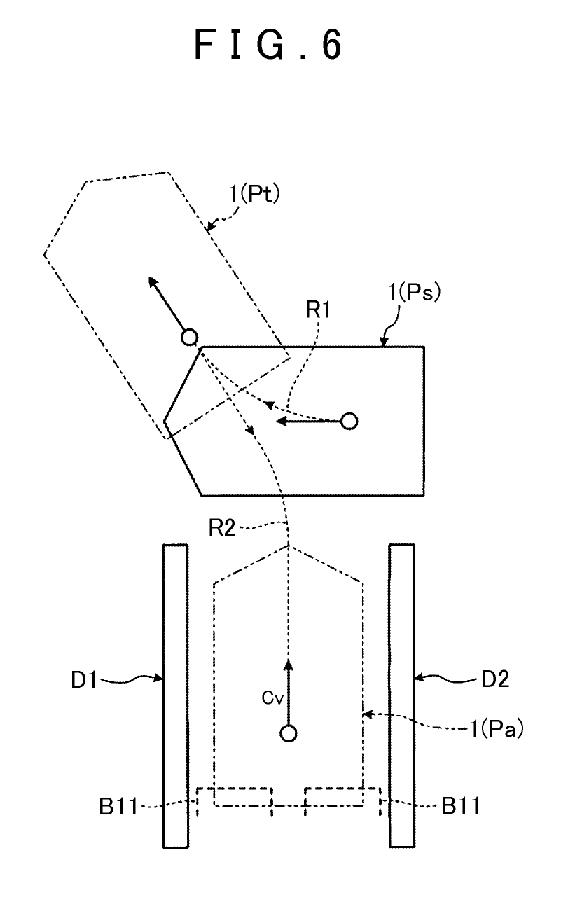

Next, the procedure of determining a target position by the ECU 14 of the parking assist system 100 according to the present embodiment will be described with reference to FIG. 6 to FIG. 15. The procedure of determining a target position Pa in the case where the vehicle 1 located at an initial position Ps moves along paths R1, R2 to the target position Pa as shown in FIG. 6 will be described. When the vehicle 1 moves along the paths R1, R2, the vehicle 1 moves back at a moving-back position (switching position) Pt. The target position Pa and the paths R1, R2 are set on the basis of detected results of parking boundaries D1, D2, an obstacle B11, another obstacle (not shown), and the like, when the vehicle 1 is located at the initial position Ps. Specifically, for example, in the ECU 14, the positions of the detected parking boundaries D1, D2, an obstacle B11, and the like, are transformed into positions on a coordinate system in plan view from the upper side of the vehicle 1 as illustrated in FIG. 6 by, for example, coordinate transformation based on calibration or geometric computation, and the target position Pa, the paths R1, R2, and the like, are calculated on the coordinate system.

In the example of FIG. 6, the target position Pa is set between the detected parking boundaries D1, D2. The target position Pa is set such that the vehicle 1 located at the target position Pa overlaps with the obstacle B11. That is, the obstacle B11 is an example of a first obstacle with which the vehicle 1 located at the target position Pa is allowed to overlap.

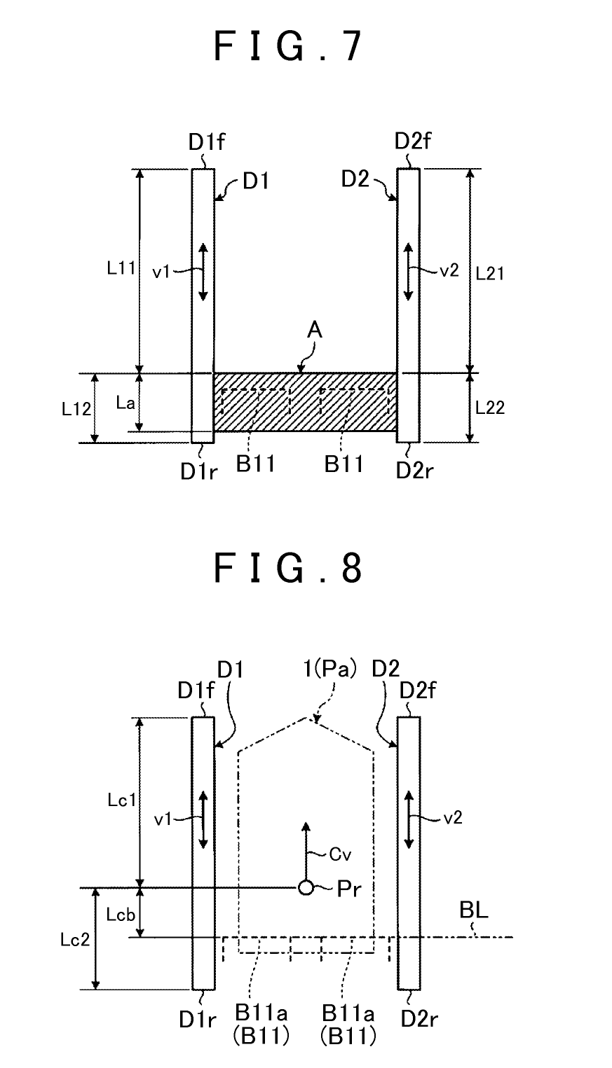

A detection range A in which the obstacle B11 is detected is set to a range in which a sprag is detectable on a back side (rear side, and lower side in FIG. 7) with respect to a middle position of the parking space in the longitudinal direction of the parking space on the basis of the detected parking boundaries D1, D2, as illustrated in FIG. 7. Specifically, the detection range A is, for example, set to a range in which a distance along a direction v1 from an entrance-side (front-side, and upper-side in FIG. 7) end D1f of the parking boundary D1 is longer than or equal to a distance L11 in an area between the two parking boundaries D1, D2. The direction v1 is a direction (longitudinal direction) in which the parking boundary D1 extends. A length La is the length of the detection range A along the direction v1, and La is shorter than L11. The direction v1 may be, for example, calculated through least square approximation, or the like, of coordinates of pixels that constitute an image of the parking boundary D1.

The detection range A is not limited to the above-described example, and may be variously set. For example, the detection range A may be set to a range in which a distance along the direction v1 from a back-side (rear-side, and lower-side in FIG. 7) end D1r of the parking boundary D1 is longer than or equal to a distance (L12-La) and shorter than or equal to a distance L12. Here, L12 is shorter than L11. The detection range A may be set to a range in which a distance along a direction v2 from an entrance-side (front-side, and upper-side in FIG. 7) end D2f of the parking boundary D2 is longer than or equal to a distance L21 and shorter than or equal to a distance (L21+La). The direction v2 is a direction in which the parking boundary D2 extends, and L21 is equal to L11. The direction v2 may be, for example, calculated through least square approximation, or the like, of coordinates of pixels that constitute an image of the parking boundary D2. The detection range A may be set to a range in which a distance along the direction v2 from a back-side (rear-side, and lower-side in FIG. 7) end D2r of the parking boundary D2 is longer than or equal to a distance (L22-La) and shorter than or equal to a distance L22. Here, L22 is equal to L12. The detection range A may be set in accordance with the above-described procedure with reference to the end (end D1f or end D2f) of one of the parking boundaries D1, D2, projecting toward the entrance side (front side, and upper side in FIG. 7) along an intermediate direction between the directions v1, v2.

The detection range A just needs to be set to a back-side position within the parking space (available parking space) that is determined on the basis of the parking boundaries D1, D2, and is not limited to the above-described example. The back-side position within the parking space is, for example, a position on the back side with respect to the center of each of the parking boundaries D1, D2 in the longitudinal direction in the area between the parking boundaries D1, D2. The back side is a side farther from the entrance of the parking space or a side farther from the vehicle 1 at the initial position than the center position in the longitudinal direction. The detection range A may have any one of various shapes, such as an elliptical shape and an oval shape.

The first obstacle detection unit 142a detects whether there is an obstacle B11 within the detection range A set on the basis of the parking boundaries D1, D2. The first obstacle detection unit 142a is able to detect an obstacle having a height lower than a predetermined height (threshold) as the obstacle B11 that may overlap with the vehicle 1 located at the target position Pa, and detect an obstacle having a height higher than or equal to the predetermined height as an obstacle that is different from the obstacle B11 and that should avoid interference with the vehicle 1.

The first obstacle detection unit 142a is able to detect an obstacle having a predetermined shape (first shape) among obstacles located within the detection range A as the obstacle B11 that may overlap with the vehicle 1 located at the target position Pa. In this case, the first obstacle detection unit 142a is, for example, able to detect the obstacle B11 by pattern matching. Specifically, for example, the first obstacle detection unit 142a calculates a similarity in shape between each of pieces of reference data of a plurality of obstacles, stored in the storage unit 149, and detected data (image) of an obstacle detected within the detection range A, and, when the similarity between the detected data and any one of the pieces of reference data is larger than or equal to a threshold, the first obstacle detection unit 142a is allowed to detect the obstacle of the detected data as the obstacle B11. Specifically, the first obstacle detection unit 142a calculates a similarity in shape between each of pieces of reference data of obstacles, which are a plurality of objects stored in the storage unit 149, and the detected data (image) of an obstacle detected within the detection range A, determines whether any one of the calculated similarities is larger than or equal to the threshold, and identifies the detected obstacle as the first obstacle when the any one of the calculated similarities is larger than or equal to the threshold. The first obstacle detection unit 142a is, for example, able to detect the obstacle B11 by comparing a feature amount of an obstacle. Specifically, for example, when a difference between a reference value of a feature amount, stored in the storage unit 149, and a detected value of a feature amount of an obstacle detected within the detection range A is smaller than or equal to a threshold, the first obstacle detection unit 142a is allowed to detect the obstacle as the obstacle B11. The feature amount includes, for example, the position (center of gravity), size (area), length, orientation (angle with respect to the longitudinal direction of a parking boundary), height, and the like, of an obstacle. In this case, when a difference in each of the plurality of feature amounts is smaller than or equal to a corresponding one of thresholds, the first obstacle detection unit 142a may detect the obstacle as the obstacle B11.

The target position determination unit 145 determines a target position Pa on the basis of at least one of the parking boundaries D1, D2. In this case, for example, as shown in FIG. 8, the target position Pa is set such that a reference point Pr of the vehicle 1 located at the target position Pa is located a distance Lc1 apart rearward along the direction v1 from the entrance-side end D1f of the parking boundary D1. The orientation Cv at the target position Pa is set so as to coincide with the intermediate direction between the direction v1 and the direction v2. The target position Pa is set such that a distance from the parking boundary D1 to the reference point Pr is equal to a distance from the parking boundary D2 to the reference point Pr.

As is apparent from FIG. 8, the vehicle 1 located at the target position Pa overlaps with the obstacle B11. If the target position Pa is set on a further forward side so as to avoid the obstacle B11, the vehicle 1 located at the target position Pa extends off forward from the parking space, so there can be a case where it is not possible to set a further appropriate target position Pa. In this regard, in the present embodiment, the target position determination unit 145 is able to set the target position Pa such that the vehicle 1 located at the target position Pa is allowed to overlap with the obstacle B11, so, for example, the number of cases where the target position Pa is not set reduces or the target position Pa is easy to be set to a further appropriate position.

The target position determination unit 145 is able to determine the target position Pa on the basis of the obstacle B11 that may be assumed as a sprag. In this case, for example, as shown in FIG. 8, the target position Pa is set such that the reference point Pr is located a distance Lcb apart forward along the intermediate direction between the direction v1 and the direction v2 from an extension B11a of the obstacle B11, which extends while intersecting with the parking boundaries D1, D2. In this case, the extension B11a is, for example, set as a portion of the obstacle B11, which intersects with one of the direction v1 and direction v2 within a predetermined angular range including 90° and which has a length within a predetermined range along the intersecting direction. The distance Lcb may be set to a distance from a line BL obtained by least square approximation of a pixel group that constitutes an image of the extension B11a. In this case, by setting the distance Lcb commensurately with the dimensions of the vehicle 1 as needed, it is possible to set the target position Pa to a position at which the rear wheels contact the obstacle B11, which may be assumed as a sprag, to stop or to a position close to that position.

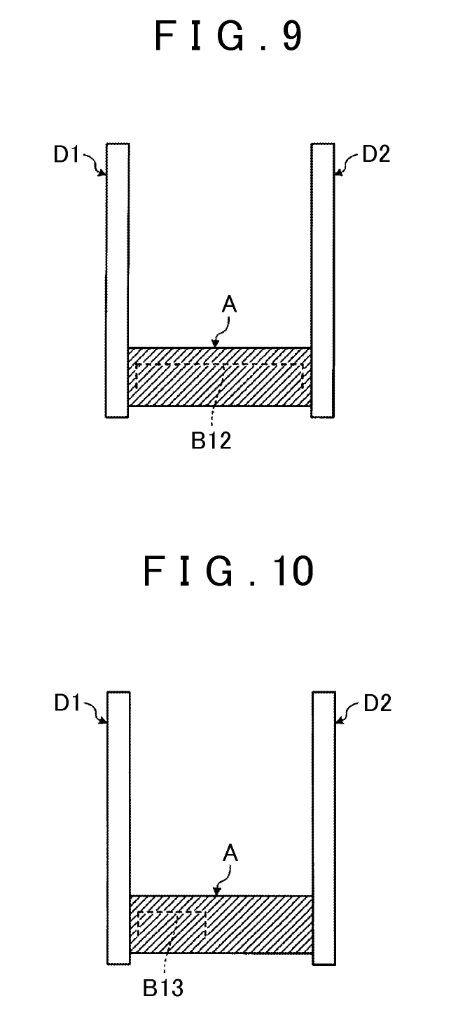

As illustrated in FIG. 9 and FIG. 10, the first obstacle detection unit 142a is able to detect an obstacle having any one of various shapes corresponding to a sprag as an obstacle B12 or an obstacle B13. Each of the obstacles B12, B13 is an example of the first obstacle. The examples of the obstacles B11, B12, B13 shown in FIG. 7, FIG. 9 and FIG. 10 are illustrative. The first obstacle detection unit 142a may detect an obstacle having another one of various shapes as the first obstacle. In this case, the first obstacle detection unit 142a may detect an obstacle that coincides with a predetermined shape or that is similar to the predetermined shape as the first obstacle by, for example, the above-described pattern matching or comparing feature amounts.

The second obstacle detection unit 142b detects an obstacle that has a predetermined shape (second shape), that is, an obstacle that coincides with a predetermined shape or is similar to the predetermined shape, and at least part of which is directed in a predetermined direction, as an obstacle B2 that may overlap with the vehicle 1 located at the target position Pa as shown in FIG. 11, irrespective of the detection range A. The first shape and the second shape may be set to similar shapes. The obstacle B2 is an example of a second obstacle.

In this case, the second obstacle detection unit 142b is, for example, able to detect the obstacle B2 by pattern matching or comparing feature amounts. Specifically, for example, as shown in FIG. 11, when an obstacle has two front portions B2a that extend substantially along the width direction (horizontal direction in FIG. 11) of the parking space or each of the parking boundaries D1, D2 on the entrance side (front side, and upper side in FIG. 11), the length of each front portion B2a falls within a predetermined range, an angular difference between a direction v3 (longitudinal direction) in which each front portion B2a extends and each of the directions v1, v2 falls within a predetermined range including a perpendicular state (90°), and a space 8 along the direction v3 between the two front portions B2a falls within a predetermined range, the second obstacle detection unit 142b detects the obstacle as the obstacle B2 that may overlap with the vehicle 1 located at the target position Pa. In this way, when the ranges of parameters that indicate a shape and a direction are set as needed, an obstacle of which the parameters fall within the corresponding ranges are detected as the obstacle B2 corresponding to a sprag. The condition of the obstacle B2 (second obstacle) described here is illustrative, and other various conditions may be set. For example, as illustrated in FIG. 11, a state where an obstacle has side portions B2b respectively extending along the longitudinal direction from the ends of the corresponding front portions B2a in the width direction toward the back side (rear side) may be included in the condition of the second obstacle.

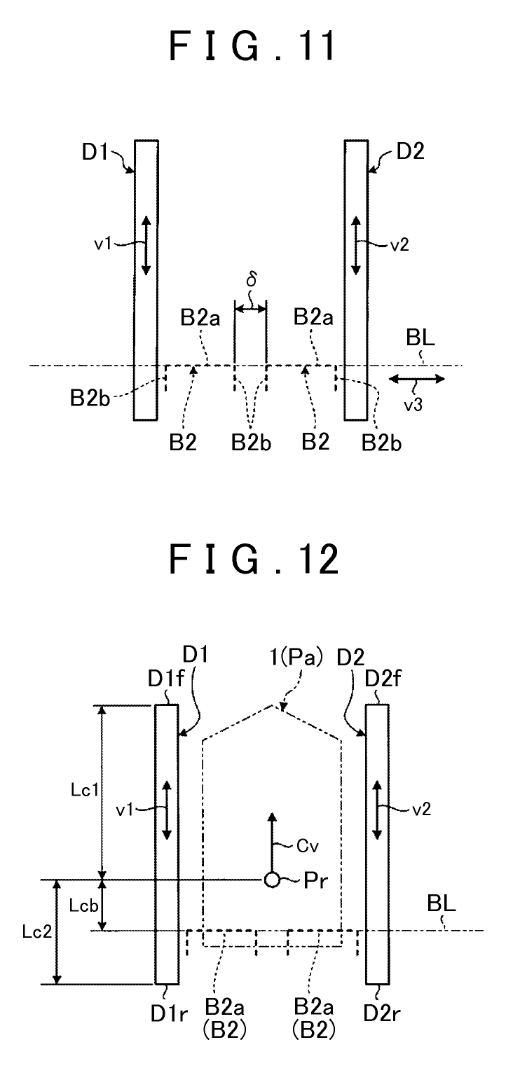

In the example of FIG. 11, as illustrated in FIG. 12, the target position determination unit 145 is able to set the position of the reference point Pr of the vehicle 1 located at the target position Pa on the basis of the parking boundaries D1, D2 or the obstacle B2. Setting of the position of the reference point Pr and the position of the target position Pa based on the distances Lc1, Lc2, Lcb in this case is similar to setting of the position of the reference point Pr and the position of the target position Pa based on the obstacle B11 detected within the detection range A. The position of the target position Pa in the width direction (horizontal direction in FIG. 11 and FIG. 12) and the orientation Cv of the vehicle 1 at the target position Pa may also be set in accordance with a procedure similar to the above-described procedure.

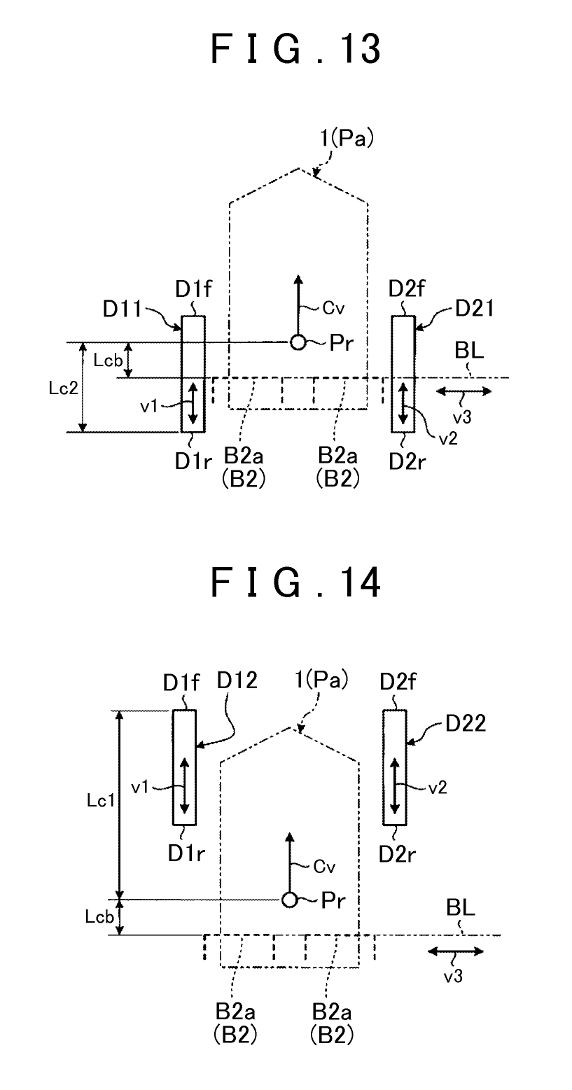

In this case, the target position determination unit 145 is also able to set a target position Pa for a parking space having parking boundaries D11, D21 that have a short length in the longitudinal direction and that are located near the back side (rear side) as illustrated in FIG. 13 or a parking space having parking boundaries D12, D22 that have a short length in the longitudinal direction and that are located near the entrance side (front side) as illustrated in FIG. 14. For example, in both the case of FIG. 13 and the case of FIG. 14, the target position determination unit 145 is able to determine the position of the reference point Pr located the distance Lcb apart from the obstacle B2 by a similar procedure to the above-described procedure based on the distance Lcb from the obstacle B11. As illustrated in FIG. 13, when the obstacle B2 and each of the parking boundaries D11, D21 are located relatively close to each other (a distance between the obstacle B2 and each of the parking boundaries D11, D21 falls within a predetermined threshold), the target position determination unit 145 may set a target position Pa such that a reference point Pr is located the distance Lc2 from each of the back-side (rear-side, and lower-side in FIG. 13) ends D1r, D2r of the parking boundaries D11, D21. As illustrated in FIG. 14, when the obstacle B2 and each of the parking boundaries D12, D22 are located relatively far from each other (a distance between the obstacle B2 and each of the parking boundaries D12, D22 falls outside the predetermined threshold), the target position determination unit 145 may set a target position Pa such that a reference point Pr is located the distance Lc1 from each of the entrance-side (front-side, and upper-side in FIG. 14) ends D1f, D2f of the parking boundaries D12, D22.

The target position determination unit 145 is able to determine the target position Pa when at least one of the obstacle B11 and the obstacle B2 has been detected. The target position determination unit 145 may set a target position Pa to a middle position between the target positions Pa respectively calculated on the basis of the plurality of detected obstacles B11, B2, or may employ a computed result based on one of the obstacles B11, B2, having a higher priority set in advance. The detected obstacles B11, B2 may be the same.

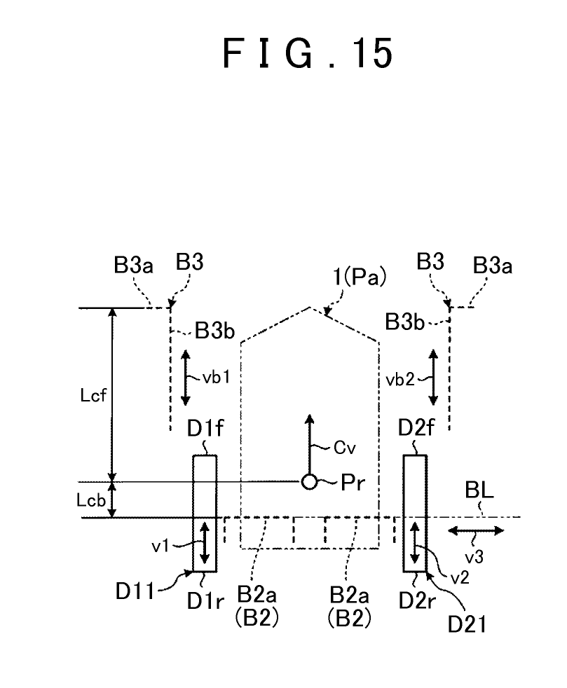

As illustrated in FIG. 15, when an obstacle has an end B3a located at the entrance side (front side, and upper side in FIG. 15) and an extension B3b that extends along a direction vb1 or direction vb2 from the end B3a, and when an angular difference between the direction vb1 or direction vb2 and at least one of the direction v1 and the direction v2 falls within a predetermined range including a parallel state (0°), the third obstacle detection unit 142c detects the obstacle as an obstacle B3 with which the vehicle 1 avoids interference. In this case, when the ranges of parameters, such as the positions of the end B3a and extension B3b, are set as needed, the obstacle B3 corresponding to an object, such as a vehicle and a wall, present in an adjacent parking space may be detected.

In the example of FIG. 15, the target position determination unit 145 may determine the position of the reference point Pr of the vehicle 1 located at the target position Pa on the basis of the obstacle B3. In this case, the target position determination unit 145 is able to set the target position Pa such that the reference point Pr is located a distance Lcf away from the end B3a along the direction v1 toward the back side (rear side, and lower side in FIG. 15). The distance Lcf is set commensurately with the vehicle 1. The position of the target position Pa in the width direction (horizontal direction in FIG. 15) and the orientation Cv of the vehicle 1 at the target position Pa may also be set in accordance with a procedure similar to the above-described procedure.

Although not shown in the drawing, in the middle of movement of the vehicle 1 along the paths P1, P2, the path setting unit 147 is able to update an initial target position Pa on the basis of the detected results of the obstacle detection units 142a to 142c, parking space detection unit 143, and the like, in the middle of the movement. As a distance from the vehicle 1 reduces, the detection accuracy of the parking boundaries D1, D2 and obstacles B11, B12, B13, B2 may increase. Thus, according to the present embodiment, a target position may be further accurately corrected.

As described above in the present embodiment, for example, the first obstacle detection unit 142a detects the obstacle B11 (first obstacle) within the detection range A (detection area) set at the back side within the parking space on the basis of the detected parking boundaries D1, D2 (boundaries). Specifically, for example, the first obstacle detection unit 142a detects the obstacle B11 within the detection range A in which a distance from each of the ends D1r, D2r of the parking boundaries D1, D2 in the corresponding longitudinal directions v1, v2 along the longitudinal directions v1, v2 falls within the predetermined range. The target position determination unit 145 is able to determine the target position Pa such that the vehicle 1 located at the target position Pa overlaps with the obstacle B11. Thus, for example, in comparison with the case where the target position Pa is set only in an area avoiding the obstacle, the number of cases where the target position Pa is allowed to be set tends to increase.

In the present embodiment, for example, when the obstacle B11, obstacle b12 or obstacle B13 (first obstacle) has the predetermined shape (first shape), the target position determination unit 145 is able to determine the target position Pa such that the vehicle 1 located at the target position Pa overlaps with the obstacle B11, the obstacle B12, or the obstacle B13. Thus, it is possible to set a condition (constraint) based on a shape in order to detect the obstacle B11, the obstacle B12, or the obstacle B13 that may overlap with the vehicle 1 located at the target position Pa. Thus, for example, an obstacle that intrinsically should not overlap with the vehicle 1 or that is desired not to overlap with the vehicle 1 tends to be prevented from overlapping with the vehicle 1. For example, depending on at least one of setting of the position and range of the detection range A (predetermined range) to relatively narrow position and range and setting of the condition based on a shape to a relatively strict condition, identification based on the height of an obstacle may be unnecessary.

In the present embodiment, for example, the second obstacle detection unit 142b detects the obstacle B2 (second obstacle) that extends in the direction v3 intersecting with the longitudinal directions v1, v2 of the parking boundaries and that has the predetermined shape (second shape), and the target position determination unit 145 is able to determine the target position Pa such that the vehicle 1 located at the target position Pa overlaps with the obstacle B2. Thus, for example, in comparison with the case where the target position Pa is set only in an area avoiding the obstacle B2, the number of cases where the target position is allowed to be set tends to increase. A condition (constraint) based on a shape may be set in order to detect the obstacle B2. Thus, for example, an obstacle that intrinsically should not overlap with the vehicle 1 or that is desired not to overlap with the vehicle 1 tends to be prevented from overlapping with the vehicle 1. There is such a merit that it is possible to identify the obstacle B2 that overlaps with the vehicle 1 when the detection area A for the obstacle B11, B12, or B13 (first obstacle) based on the parking boundaries D1, D11, D12, D2, D21, D22 is difficult to be set, for example, when the parking boundaries D1, D11, D12, D2, D21, D22 are short. It is possible to detect an obstacle, such as a flap other than a sprag, that may overlap with the vehicle 1 as the obstacle B2.

In the present embodiment, for example, the target position determination unit 145 is able to determine the target position Pa on the basis of at least one of the obstacle B11 and the obstacle B2. Thus, for example, the target position Pa corresponding to at least one of the obstacle B11 and the obstacle B2 may be set. The number of cases where the target position Pa is allowed to be set further tends to increase.

In the present embodiment, for example, the third obstacle detection unit 142c detects the obstacle B3 (third obstacle) that extends substantially along the direction in which at least one of the parking boundaries D1, D2 extends, and the target position determination unit 145 is able to determine the target position Pa on the basis of the detected obstacle B3. Thus, for example, in comparison with the case where there is no obstacle B3, the number of cases where the target position Pa is set tends to increase.

The embodiment of the invention is illustrated above; however, the above-described embodiment is illustrative, and is not intended to limit the scope of the invention. The embodiment may be implemented in other various forms, and may be variously omitted, replaced, combined or changed without departing from the spirit of the invention. The components and shapes of each embodiment may be partially replaced. The specifications (structure, type, orientation, shape, size, length, width, height, number, arrangement, position, and the like) of each component, or the like, may be changed as needed. The invention is applicable to parking assist in parking places and parking spaces in various forms. According to the invention, even when a single parking boundary has been detected, for example, it is possible to determine a target position on the basis of the single parking boundary by, for example, setting a target parallel to the parking boundary at a position located a predetermined distance from the parking boundary. The invention is applicable to setting of a plurality of target position candidates. When a condition based on a shape, height, or the like, is set as needed for an obstacle that may overlap with a vehicle, a detection area may be set so as to include an entrance side within a parking space.

What is claimed is:

1. A parking assist system comprising:
an electronic control unit configured to
detect a boundary of a parking space,
detect a first obstacle within a detection area set at a back-side position within the parking space on the basis of the detected boundary,
determine a target position of a moving path of a vehicle on the basis of the detected boundary, and
determine the target position such that the vehicle located at the target position overlaps with the first obstacle.

2. The parking assist system according to claim 1, wherein
the electronic control unit is configured to, when the first obstacle has a first shape, determine the target position such that the vehicle located at the target position overlaps with the first obstacle.

3. The parking assist system according to claim 1, wherein
the electronic control unit is configured to detect a second obstacle that extends in a direction intersecting with a longitudinal direction of the detected boundary and that has a second shape different from a shape of the first obstacle, and
the electronic control unit is configured to determine the target position such that the vehicle located at the target position overlaps with the second obstacle.

4. The parking assist system according to claim 3, wherein
the electronic control unit is configured to determine the target position on the basis of at least one of the detected first obstacle and the detected second obstacle.

5. The parking assist system according to claim 1, wherein
the electronic control unit is configured to detect a third obstacle that extends substantially along a longitudinal direction of the detected boundary, and
the electronic control unit is configured to determine the target position on the basis of the detected third obstacle.

6. A parking assist system comprising
an electronic control unit including a storage unit that is configured to store a plurality of objects,
wherein the electronic control unit is configured to
detect a boundary of a parking space,
detect an obstacle within a detection area set at a back-side position within the parking space on the basis of the detected boundary,
determine whether a similarity of the obstacle to any one of the objects stored in the storage unit is larger than or equal to a threshold,
when the similarity of the obstacle to any one of the objects is larger than or equal to the threshold, identify the obstacle as a first obstacle,
determine a target position of a moving path of a vehicle on the basis of the detected boundary, and
determine the target position such that the vehicle located at the target position overlaps with the first obstacle.

7. A parking assist method comprising:
detecting a boundary of a parking space;
detecting a first obstacle within a detection area set at a back-side position within the parking space on the basis of the detected boundary;
determining a target position of a moving path of a vehicle on the basis of the detected boundary; and
determining the target position such that the vehicle located at the target position overlaps with the first obstacle.
